(19) United States
(12) Patent Application Publication
(10) Pub. No.: US 2024/0309999 A1
(43) Pub. Date: Sep. 19, 2024

(54) METHOD AND SYSTEM FOR DIAGNOSING LEAKAGE IN HYDROGEN SYSTEM FOR VEHICLE, ELECTRONIC DEVICE, AND STORAGE MEDIUM

(71) Applicant: Beijing Institute of Technology, Beijing (CN)

(72) Inventors: Jianwei Li, Beijing (CN); Chonghao Yan, Beijing (CN); Xinming Wan, Beijing (CN); Xuechao Wang, Beijing (CN); Rongxue Kang, Beijing (CN); Zhiwei Zhao, Beijing (CN)

(21) Appl. No.: 18/605,923

(22) Filed: Mar. 15, 2024

(30) Foreign Application Priority Data
Mar. 16, 2023 (CN) 2023102504295

(51) Int. Cl. F17C 13/02; G01M 3/32; G06V 10/82

(52) U.S. Cl. CPC F17C 13/025; G01M 3/3272; G06V 10/82; F17C 2260/038

(57) ABSTRACT

The present disclosure provides a method and system for diagnosing a leakage in a hydrogen system for a vehicle, an electronic device, and a storage medium. The method includes: obtaining data of a hydrogen cylinder gas pressure of a fuel cell vehicle; separately performing Gramian angular field transformation and Markov transition field transformation on the pressure data, to obtain static and dynamic feature information; performing, by a static feature LeNet neural network, recognition based on the static feature information, to obtain a probability output of the static feature LeNet neural network; performing, by a dynamic feature LeNet neural network, recognition based on the dynamic feature information, to obtain a probability output of the dynamic feature LeNet neural network; and performing fusion through a Dempster-Shafer (D-S) evidence theory based on the probability output of the static and dynamic feature LeNet neural network, to obtain an excellent hydrogen leakage diagnosis result.

### CROSS REFERENCE TO RELATED APPLICATION

This patent application claims the benefit and priority of Chinese Patent Application No. 2023102504295, filed with the China National Intellectual Property Administration on Mar. 16, 2023, the disclosure of which is incorporated by reference herein in its entirety as part of the present application.

### TECHNICAL FIELD

The present disclosure relates to the field of hydrogen leakages, and in particular to a method and system for diagnosing a leakage in a hydrogen system for a vehicle, an electronic device, and a storage medium.

### BACKGROUND

A hydrogen fuel cell vehicle is a vehicle that uses hydrogen as an energy source, converts chemical energy of hydrogen into electrical energy through a fuel cell, and generates kinetic energy by an electric motor.

However, hydrogen is flammable. Once hydrogen leaks, especially a large flow of hydrogen leaks from the fuel cell vehicle because of a collision or impact of another object, a concentration of hydrogen close to a leakage point is increased rapidly, causing dangers such as combustion and explosion. Pressures of hydrogen in a hydrogen cylinder and pipelines adjacent to the hydrogen cylinder in the fuel cell vehicle reach 70 MPa. Therefore, hydrogen is easy to leak. The large flow of hydrogen may leak from a small leakage hole. Although a crash test is strictly performed for the fuel cell vehicle during production, performance of a seal used in a hydrogen supply system may be reduced because of aging or damage during long-term use. As a result, a large flow of hydrogen leaks in a traffic accident. More seriously, some studies show that although there is no ignition source, hydrogen released from a high-pressure area may be ignited. Therefore, research on diagnosis for a high-pressure hydrogen leakage is of great significance for safe operations of the fuel cell vehicle.

At present, for most leakages of hydrogen from the fuel cell vehicle, a concentration of hydrogen in the air is diagnosed by a sensor. However, this method is easy to be affected by a quantity and locations of mounted sensors. When the mounted sensors are located far away from the leak point, a lot of time is taken to diagnose the leakage. When the hydrogen leakage point is blocked with an object between the leakage point and the sensor, the sensor does not obtain information about diffusion concentration of hydrogen in a timely manner. As a result, the diagnosis time is long, or even the hydrogen leakage is not accurately diagnosed. Because diagnosis for an odor-based and sound-based fault needs to be manually performed by a driver, the hydrogen leakage is not automatically diagnosed through calculation. Because diagnosis for a model-based fault becomes more complex with an actual system, it is difficult to accurately establish a physical model of the system as the actual system. Because diagnosis for a conventional data-driven fault needs to be performed depending on features extracted from expert experience, a lot of time is consumed for the diagnosis, and diagnosis performance is significantly affected.

In conclusion, an existing method for diagnosing a leakage in a hydrogen system for a fuel cell vehicle does not recognize the leakage in the hydrogen system quickly, efficiently, and accurately.

### SUMMARY

An objective of the present disclosure is to provide a method and system for diagnosing a leakage in a hydrogen system for a vehicle, an electronic device, and a storage medium, to improve speed and accuracy in diagnosing the leakage in the hydrogen system.

To achieve the above objective, the present disclosure provides the following technical solutions.

A method for diagnosing a leakage in a hydrogen system for a vehicle includes:
obtaining data of an actual gas pressure inside a hydrogen cylinder of a fuel cell vehicle;
separately performing Gramian angular field transformation and Markov transition field transformation on the data of the actual gas pressure, to obtain static feature information and dynamic feature information;
performing, by a static feature LeNet neural network, recognition based on the static feature information, to obtain a probability output of the static feature LeNet neural network;
performing, by a dynamic feature LeNet neural network, recognition based on the dynamic feature information, to obtain a probability output of the dynamic feature LeNet neural network; and
performing fusion through a Dempster-Shafer (D-S) evidence theory based on the probability output of the static feature LeNet neural network and the probability output of the dynamic feature LeNet neural network, to obtain a hydrogen leakage diagnosis result.

Optionally, the separately performing Gramian angular field transformation and Markov transition field transformation on the data of the actual gas pressure, to obtain static feature information and dynamic feature information specifically includes:
performing normalization processing and polar coordinate transformation on the data of the actual gas pressure, to obtain transformed data;
calculating a Gramian angular summation field based on the transformed data;
determining the static feature information based on the Gramian angular summation field;
performing a binning operation on the data of the actual gas pressure, to obtain a binning probability;
determining a Markov transition matrix based on the binning probability;
constructing a Markov transition field based on the Markov transition matrix; and
determining the dynamic feature information based on the Markov transition field.

Optionally, a training process of the static feature LeNet neural network includes:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, where the different operating condition includes a normal operating condition and a hydrogen leakage condition.

Optionally a training process of the dynamic feature LeNet neural network includes:
migrating, based on a migration learning algorithm, a network parameter of the static feature LeNet neural network to a second LeNet neural network, taking actual dynamic feature data under the different operating conditions as an input of the second LeNet neural network, taking a probability output of the LeNet neural network with dynamic feature input extracted under actual conditions as an output of the second LeNet neural network, and optimizing a network parameter of the second LeNet neural network, to obtain the dynamic feature LeNet neural network.

Optionally, the performing fusion through a Dempster-Shafer (D-S) evidence theory based on the probability output of the static feature LeNet neural network and the probability output of the dynamic feature LeNet neural network, to obtain a hydrogen leakage diagnosis result specifically includes:
determining a normalization constant based on the probability output of the static feature LeNet neural network and the probability output of the dynamic feature LeNet neural network;
determining, through a Dempster evidence synthesis rule, a combined basic probability assignment based on the probability output of the static feature LeNet neural network, the probability output of the dynamic feature LeNet neural network, and the normalization constant; and
determining the hydrogen leakage diagnosis result based on the combined basic probability assignment.

The present disclosure further provides a system for diagnosing a leakage in a hydrogen system for a vehicle. The system includes: an obtaining module, a transformation module, a first recognition module, a second recognition module, and a fuse module.

The obtaining module is configured to obtain data of an actual gas pressure inside a hydrogen cylinder of a fuel cell vehicle.

The transformation module is configured to separately perform Gramian angular field transformation and Markov transition field transformation on the data of the actual gas pressure, to obtain static feature information and dynamic feature information.

The first recognition module is configured to perform, by a static feature LeNet neural network, recognition based on the static feature information, to obtain a probability output of the static feature LeNet neural network.

The second recognition module is configured to perform, by a dynamic feature LeNet neural network, recognition based on the dynamic feature information, to obtain a probability output of the dynamic feature LeNet neural network.

The fuse module is configured to perform fusion through a D-S evidence theory based on the probability output of the static feature LeNet neural network and the probability output of the dynamic feature LeNet neural network, to obtain a hydrogen leakage diagnosis result.

Optionally, the transformation module specifically includes: a normalization processing and polar coordinate transformation unit, a calculation unit, a static feature information determining unit, a binning operation, a Markov transition matrix determining unit, a construction unit, and a dynamic feature information determining unit.

The normalization processing and polar coordinate transformation unit is configured to perform normalization processing and polar coordinate transformation on the data of the actual gas pressure, to obtain transformed data.

The calculation unit is configured to calculate a Gramian angular summation field based on the transformed data.

The static feature information determining unit is configured to determine the static feature information based on the Gramian angular summation field.

The binning operation unit is configured to perform a binning operation on the data of the actual gas pressure, to obtain a binning probability.

The Markov transition matrix determining unit is configured to determine a Markov transition matrix based on the binning probability.

The construction unit is configured to construct a Markov transition field based on the Markov transition matrix.

The dynamic feature information determining unit is configured to determine the dynamic feature information based on the Markov transition field.

Optionally, a training process of the static feature LeNet neural network includes:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, where the different operating condition includes a normal operating condition and a hydrogen leakage condition.

The present disclosure further provides an electronic device.

The electronic device includes: one or more processors, and
a storage unit, configured to store one or more programs,
where the one or more programs, when being executed by the one or more processors, cause the one or more processors to implement the method according to any one of the foregoing items.

The present disclosure further provides a storage medium storing a computer program, where the computer program, when being executed by a processor, implements the method according to any one of the foregoing items.

According to specific embodiments provided in the present disclosure, the present disclosure has the following technical effect.

According to the present disclosure, the data of the actual gas pressure inside the hydrogen cylinder of the fuel cell vehicle is obtained, Gramian angular field transformation and Markov transition field transformation are separately performed on the data of the actual gas pressure, to obtain the static feature information and the dynamic feature information, the static feature LeNet neural network performs recognition based on the static feature information, to obtain the probability output of the static feature LeNet neural network, the dynamic feature LeNet neural network performs recognition based on the dynamic feature information, to obtain the probability output of the dynamic feature LeNet neural network, and fusion is performed through a D-S evidence theory based on the probability output of the static feature LeNet neural network and the probability output of the dynamic feature LeNet neural network, to obtain the hydrogen leakage diagnosis result. The probability output of the static feature LeNet neural network and the probability output of the dynamic feature LeNet neural network are fused through the D-S evidence theory. Because a dynamic feature and a static feature of acquired data are comprehensively considered, an optimal diagnosis output result is obtained. Therefore, accuracy and speed of diagnosis are improved.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is an overall diagram of a method for diagnosing a leakage in a hydrogen system for a vehicle according to the present disclosure;

FIG. 2 is a schematic diagram of pressure data of a high pressure hydrogen cylinder for a vehicle under a normal operating condition;

FIG. 3 is a schematic diagram of pressure data of a high pressure hydrogen cylinder for a vehicle under a hydrogen leakage condition;

FIGS. 4A-4B are flowchart of construction of a Gramian angular field;

FIG. 5 is a flowchart of construction of a Markov transition field;

FIG. 6 is a diagram of an architecture of a LeNet neural network model;

FIG. 7 is a diagram of comparison between loss values during training based on a migration learning algorithm;

FIG. 8 is a diagram of comparison between accuracy during training based on a migration learning algorithm; and

FIG. 9 is a flowchart of a method for diagnosing a leakage in a hydrogen system for a vehicle according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a method and system for diagnosing a leakage in a hydrogen system for a vehicle, an electronic device, and a storage medium, to improve speed and accuracy in diagnosing the leakage in the hydrogen system.

In order to make the above objective, features and advantages of the present disclosure clearer and more comprehensible, the present disclosure will be further described in detail below in combination with accompanying drawings and particular implementation modes.

Referring to FIG. 9, a method for diagnosing a leakage in a hydrogen system for a vehicle includes the following steps.

Step 101: Obtain data of an actual gas pressure inside a hydrogen cylinder of a fuel cell vehicle.

Step 102: Separately perform Gramian angular field transformation and Markov transition field transformation on the data of the actual gas pressure, to obtain static feature information and dynamic feature information.

Step 102 specifically includes: performing normalization processing and polar coordinate transformation on the data of the actual gas pressure, to obtain transformed data; calculating a Gramian angular summation field based on the transformed data; determining the static feature information based on the Gramian angular summation field; performing a binning operation on the data of the actual gas pressure, to obtain a binning probability; determining a Markov transition matrix based on the binning probability; constructing a Markov transition field based on the Markov transition matrix; and determining the dynamic feature information based on the Markov transition field.

Step 103: Perform, by a static feature LeNet neural network, recognition based on the static feature information, to obtain a probability output of the static feature LeNet neural network.

Step 104: Perform, by a dynamic feature LeNet neural network, recognition based on the dynamic feature information, to obtain a probability output of the dynamic feature LeNet neural network.

Step 105: Perform fusion through a Dempster-Shafer (D-S) evidence theory based on the probability output of the static feature LeNet neural network and the probability output of the dynamic feature LeNet neural network, to obtain a hydrogen leakage diagnosis result.

Step 105 specifically includes:
determining a normalization constant based on the probability output of the static feature LeNet neural network and the probability output of the dynamic feature LeNet neural network; determining, through a Dempster evidence synthesis rule, a combined basic probability assignment based on the probability output of the static feature LeNet neural network, the probability output of the dynamic feature LeNet neural network, and the normalization constant; and determining the hydrogen leakage diagnosis result based on the combined basic probability assignment.

During actual application, a training process of the static feature LeNet neural network includes:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, where the different operating condition includes a normal operating condition and a hydrogen leakage condition.

During actual application, a training process of the dynamic feature LeNet neural network includes:
migrating, based on a migration learning algorithm, a network parameter of the static feature LeNet neural network to a second LeNet neural network, taking actual dynamic feature data under the different operating conditions as an input of the second LeNet neural network, taking a probability output of the LeNet neural network with dynamic feature input extracted under actual conditions as an output of the second LeNet neural network, and optimizing a network parameter of the second LeNet neural network, to obtain the dynamic feature LeNet neural network.

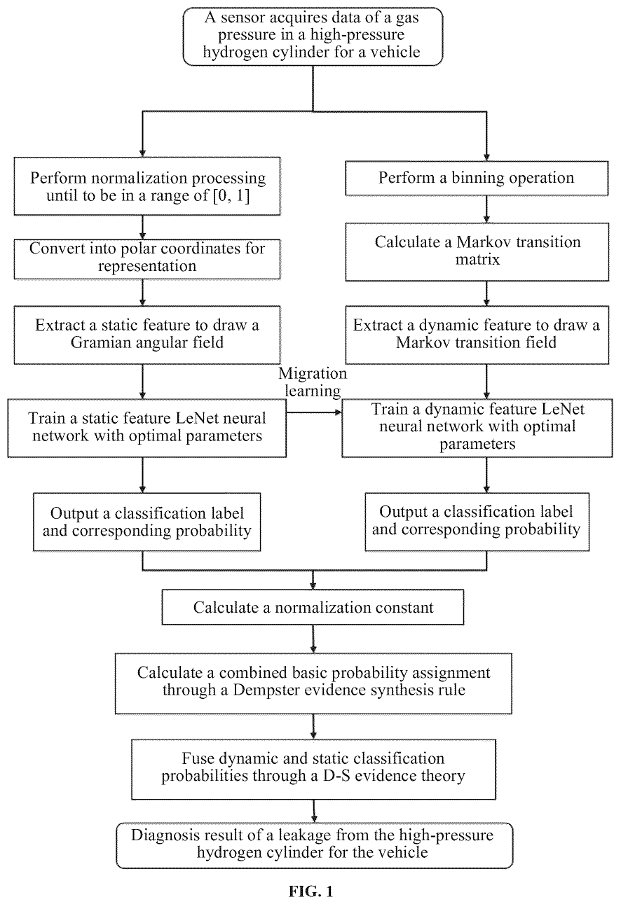

Referring to FIG. 1, the present disclosure further provides a specific procedure of implementing a method for diagnosing a leakage in a hydrogen system for a vehicle in an actual application. The specific procedure includes the following steps.

### Part 1: A One-Dimensional Signal is Converted Into a Two-Dimensional Image

In a conventional method for diagnosing a data-driven fault, a data preprocessing method plays a crucial role, because most data-driven methods do not directly process raw signals. One of main functions of the data preprocessing method is to extract a feature of the raw signal from a large amount of historical data. However, extraction of a suitable feature is laborious, and the feature has significant impact on a final result. The present disclosure develops an effective data preprocessing method. An idea of the data preprocessing method is to convert a raw time domain signal into an image.

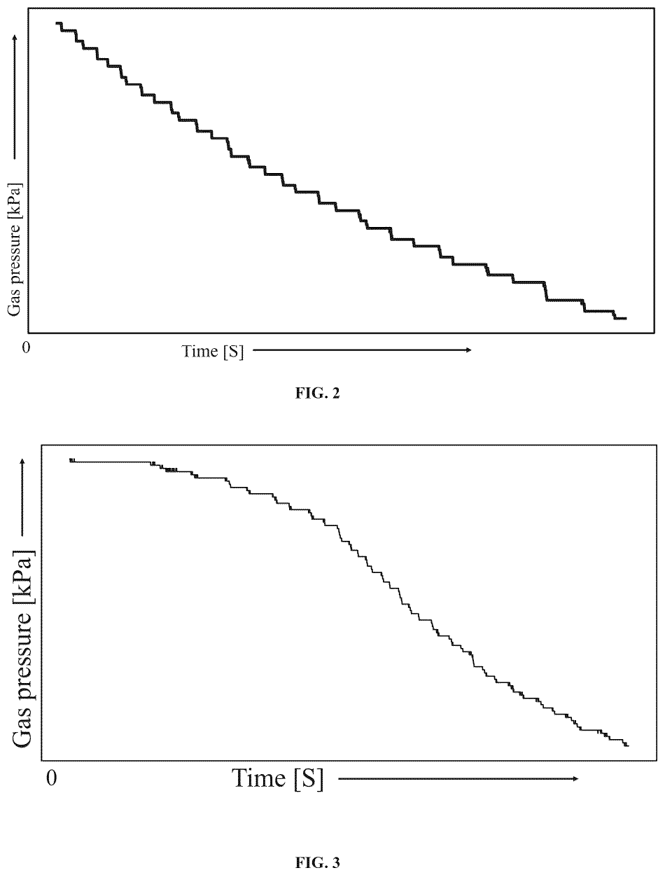

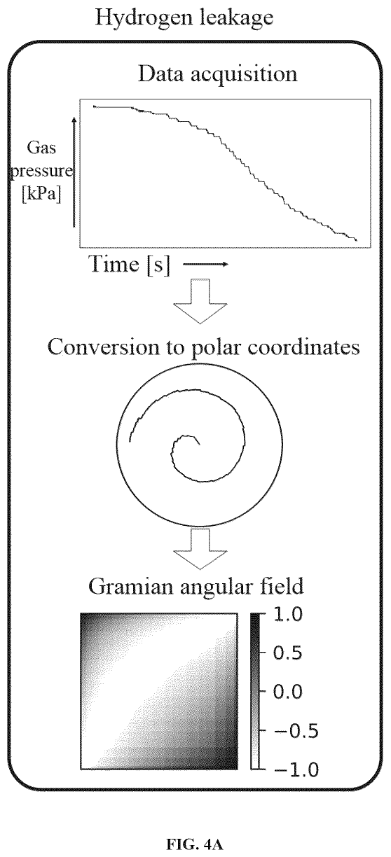

Step 1: Obtain gas pressures inside a high-pressure hydrogen cylinder of a fuel cell vehicle under a hydrogen leakage fault and a normal operating condition as shown in FIG. 2 and FIG. 3. A sensor acquires gas pressure data from the high-pressure hydrogen cylinder.

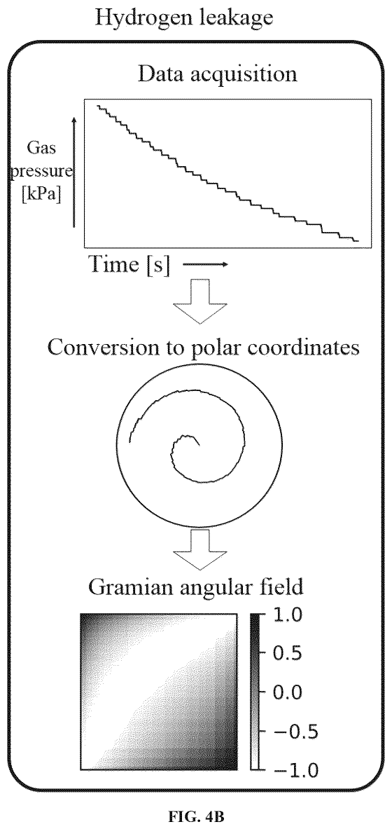

Step 2: Separately convert the two types of signals into a Gramian angular field as shown in FIGS. 4A-4B. Firstly, normalization is performed on the gas pressure data X=[x₁, x₂, x₃, . . . , x_{N}] until the gas pressure data is within a range of [0, 1]:

$${\tilde{x}}_{i} = \frac{{x}_{j} - min ( X )}{max ( X ) - min ( X )} i , j = 1 , 2 , 3 … , N , \qquad ( 1 )$$

where X represents a sequence of an obtained signal, max(X) and min (X) respectively represent a maximum signal value and a minimum signal value xⱼ represents a j^{th} signal obtained, and \tilde{x}ᵢ represents data acquired after normalization is performed on an i^{th} signal.

Secondly, the data acquired after normalization is performed is converted into polar coordinates:

$$φ = arccos ( {\tilde{x}}_{i} ) , 0 \leq {\tilde{x}}_{i} \leq 1 \qquad ( 2 )$$

$$r = \frac{{t}_{i}}{N} , {t}_{i} ∈ N ,$$

where \tilde{x}ᵢ represents the data acquired after normalization is performed on an i^{th} signal, tᵢ represents a time point at which a signal is acquired, and N represents a factor for conversion of the polar coordinates. φ represents a polar angle in a polar coordinate system, and r represents a polar path in the polar coordinate system.

A static feature is extracted to draw the Gramian angular field. The Gramian angular summation field is obtained through calculation. The Gramian angular summation field represents a temporal correlation at different time intervals while time dependence is stored, and represents static feature information of the data:

$$G A S F = [ cos ( {φ}_{i} + {φ}_{j} ) ] = \tilde{X} \cdot \tilde{X} - \sqrt{I - {\tilde{X}}^{2}} \cdot \sqrt{I - {\tilde{X}}^{2}} , \qquad ( 3 )$$

where

I represents a unit row vector [1, 1, 1 . . . , 1], \tilde{X}=[\tilde{x}₁, \tilde{x}₂, \tilde{x}₃, . . . \tilde{x}_{N}], and \tilde{X}π represents transposition of \tilde{x}. GASF represents the Gramian angular summation field, φᵢ represents, in the polar coordinate system, a polar angle of the data acquired after normalization is performed on an i^{th} signal, φⱼ represents, in the polar coordinate system, a polar angle of data acquired after normalization is performed on a j^{th} signal. \tilde{X} represents a data group after normalization is performed.

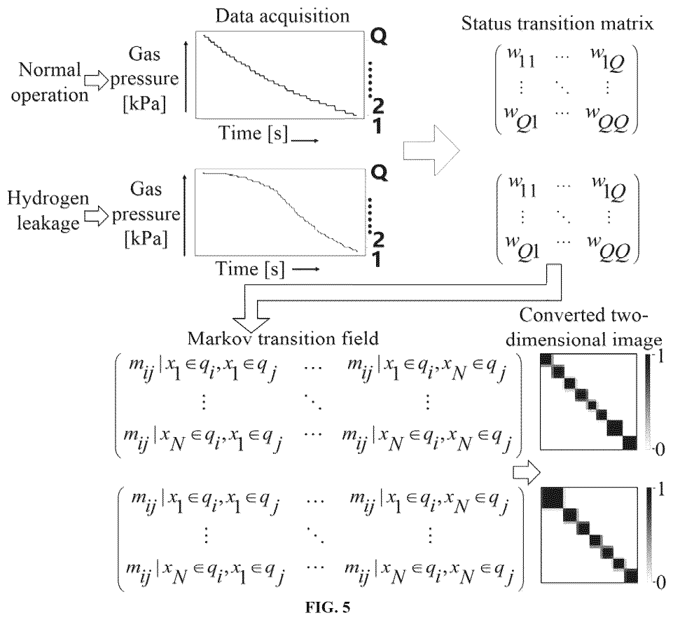

Step 3: Separately convert the two types of signals into a Markov transition field as shown in FIG. 5. Firstly, a binning operation is performed on the data, and the number of bins is set to Q. Then each acquired signal value is mapped into a corresponding bin qᵢ, i∈[1,Q]. Quartiles are converted into a Q×Q adjacent weighting matrix through a first-order Markov chain along a time axis, to calculate a Markov transfer matrix W:

$$W = [ \begin{matrix}{w}_{11} & … & {w}_{1 Q} \\ ⋮ & ⋱ & ⋮ \\ {w}_{Q 1} & … & {w}_{QQ}\end{matrix} ] , {w}_{ij} = P ( {x}_{i} ∈ {q}_{i} \vert {x}_{t - 1} ∈ {q}_{j} ) , i , j ∈ [ 1 , Q ] , \qquad ( 4 )$$

where wᵢⱼ represents probability of transiting a bin qᵢ to a bin qⱼ, and

$$\sum \text{?} w \text{?} 1.$$

$$P ( x \text{?} ∈ q \text{?} \text{?} x \text{?} ∈ q \text{?} )$$

$$\text{?} \text{indicates text missing or illegible when filed}$$

represents conditional probability, that is, probability x₁∈qᵢ of when xₜ₋₁∈qⱼ.

A dynamic feature is extracted to draw the Markov transition field. Because the acquired data is distributed along the time axis, additional temporal information is given to a state transition matrix, to construct a Markov transition field M:

$$M = ( \begin{matrix}{m}_{ij} \vert {x}_{1} ∈ {q}_{i} , {x}_{1} ∈ {q}_{j} & … & {m}_{ij} \vert {x}_{1} ∈ {q}_{i} , {x}_{N} ∈ {q}_{j} \\ ⋮ & ⋱ & ⋮ \\ {m}_{ij} \vert {x}_{N} ∈ {q}_{i} , {x}_{1} ∈ {q}_{j} & … & {m}_{ij} \vert {x}_{N} ∈ {q}_{i} , {x}_{N} ∈ {q}_{j}\end{matrix} ) , \qquad ( 5 )$$

where mᵢⱼ represents transition probability that data points belonging to the bin q₁ in a period of time k(1≤k≤N) are transited to data points belonging to the bin qⱼ in a period of time l(1≤l≤N)

The Markov transition field represents, by calculating a Markov probability transition matrix, dynamic data transition information in a two-dimensional image.

### Part 2: A Deep Learning Neural Network Model is Trained

An abstract representation feature of the acquired data is automatically learned through deep learning. This avoids extracting a feature based on expert experience. A convolutional neural network, as one of most effective deep learning techniques, is a good tool for fault diagnosis. In the present disclosure, a LeNet convolutional neural network is used to perform fault classification on the acquired data, with strong robustness and fault tolerance. In addition, an image feature loss caused by dimensionality reduction is avoided.

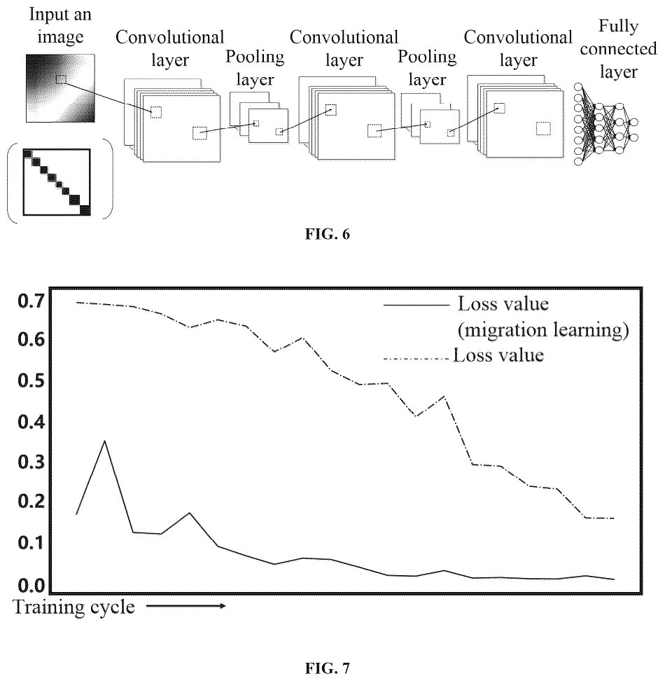

Step 1: Construct a LeNet neural network model as shown in FIG. 6. There are five weight layers in total, namely, three convolutional layers and two pooling layers. Specifically, first there are two convolutional layers. A feature is extracted by a subsampling (pooling) layer after each convolutional layer. Then, there is a single convolutional layer. Finally there are also a group of two fully connected layers. A hyperbolic tangent activation function is set before a first fully connected layer, to obtain a diagnosis output result after passing through a softmax layer.

Step 2: Train the LeNet neural network model. A static feature LeNet neural network is trained with optimal parameters, and a dynamic feature LeNet neural network is trained with optimal parameters based on migration learning. Firstly, static feature images (Gramian angular field) under the normal operating condition and a hydrogen leakage condition are taken as an input of the network, to obtain a LeNet network model with optimal parameters through training, called a static feature LeNet network. Parameters such as a weight and bias of each layer are stored. A classification label and corresponding probability are output. Dynamic feature images (Markov transition field) under the normal operating condition and the hydrogen leakage condition are taken as an input of the network. In addition, the parameters of the static feature LeNet network are loaded through migration learning, to further train the dynamic feature LeNet network. A classification label and corresponding probability are output. For data to be acquired and diagnosed, the static feature LeNet network and the dynamic feature LeNet network are entered to obtain two groups of output data:

$$Output of static feature LeNet network = ( \begin{matrix}\frac{Category}{Normal} & \frac{Probability}{{x}_{1}} \\ Leakage & {x}_{2}\end{matrix} ) ; \qquad ( 6 )$$

$$Output of dynamic feature LeNet network = ( \begin{matrix}\frac{Category}{Normal} & \frac{Probability}{{y}_{1}} \\ Leakage & {y}_{2}\end{matrix} )$$

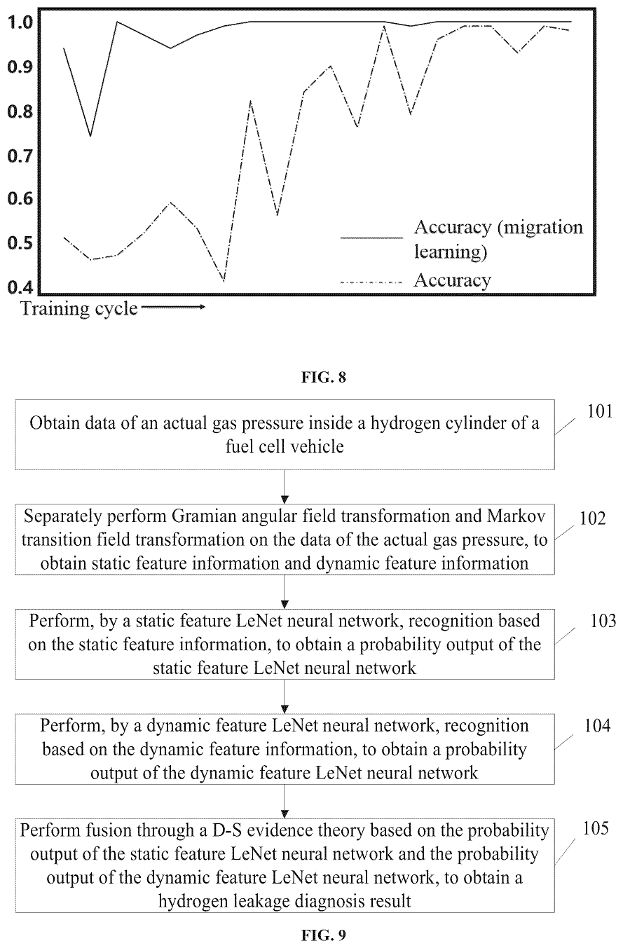

A parameter of the static feature LeNet network is loaded, to train the dynamic feature LeNet network through migration learning. Changes in accuracy and a loss value during the training process are shown in FIG. 7 and FIG. 8. FIG. 7 is a diagram of comparison between loss values during training based on a migration learning algorithm. FIG. 8 is a diagram of comparison between accuracy during training based on a migration learning algorithm. It can be learned that, after the dynamic feature LeNet network is trained through migration learning, accuracy is quickly converged, and the loss value is reduced accordingly.

### Part 3: Information Fusion is Performed Through a D-S Evidence Theory

Fault prediction probability values (x₁, x₂, y₁, y₂) are obtained based on different morphological features (static and dynamic) of the acquired signal, and two pieces of diagnosis information are fused through the D-S evidence theory, to obtain an optimal leakage diagnosis result z₁, z₂ as shown in Table 1.

TABLE 1
Output results based on D-S evidence theory

| | Probability result X | Probability result Y | Output a probability |
|---|---|---|---|
| | (static feature LeNet | (dynamic feature | result through a D-S |
| Output category | network) | LeNet network) | evidence theory |
| Normal | x₁ | y₁ | z₁ |
| Leakage | x₂ | y₂ | z₂ |

Step 1: Calculate a normalization constant K:

$$K = {\sum }_{X ⋂ Y \neq ∅} {m}_{1} ( X ) \cdot {m}_{2} ( Y ) = {x}_{1} * {y}_{1} + {x}_{2} * {y}_{2} , \qquad ( 7 )$$

where m(λ) represents a mass function, a basic probability assignment for an event (which is basic concept of the D-S evidence theory, an important step in a calculation process),

$${\sum }_{λ ∈ Θ} ( λ ) = 1 ,$$

∅ represents a null set, X represents an output of the static feature LeNet network, for example, X in Table 1, including x₁ x₂ . Y represents an output of the feature LeNet network, for example, Y in Table 1, including y₁ y₂ . Θ represents hypothesis space, a basic concept in the D-S synthesis theory, representing possibility of all events, and being understood as a full set.

Step 2: Calculate combined basic probability assignment through the Dempster evidence theory:

$${z}_{1} = {m}_{1} ⊕ {m}_{2} ( \{ Normal \} ) = \frac{1}{K} {\sum }_{X ⋂ Y = \{ Normal \}} {m}_{1} ( X ) \cdot {m}_{2} ( Y ) = \frac{1}{K} \cdot {m}_{1} ( \{ Normal \} ) \cdot {m}_{2} ( \{ Normal \} ) = \frac{1}{{x}_{1} * {y}_{1} + {x}_{2} * {y}_{2}} \cdot {x}_{1} \cdot {y}_{1} \qquad ( 8 )$$

$${z}_{2} = {m}_{1} ⊕ {m}_{2} ( \{ Leakage \} ) = \frac{1}{K} {\sum }_{X ⋂ Y = \{ Leakage \}} {m}_{1} ( X ) \cdot {m}_{2} ( Y ) = \frac{1}{K} \cdot {m}_{1} ( \{ Leakage \} ) \cdot {m}_{2} ( \{ Leakage \} ) = \frac{1}{{x}_{1} * {y}_{1} + {x}_{2} * {y}_{2}} \cdot {x}_{2} \cdot {y}_{2} \qquad ( 9 )$$

m₁ represents a class 1 of a discriminator, m₂ represents a class 2 of a discriminator, m₂ ({Normal}) represents probability that an output of the class 2 of the discriminator (the dynamic feature LeNet network) is “normal”, m₁(x) represents a possible result for the class 1 of the discriminator, m₂(Y) represents a possible result for the class 2 of the discriminator, m₁({Normal}) represents probability that an output of the class 1 of the discriminator (the static feature LeNet network) is “normal”, m₂({Leakage}) represents probability that the output of the class 2 of the discriminator (the dynamic feature LeNet network) is “leakage”, and m₁({Leakage}) represents probability that an output of the class 1 of the discriminator (the static feature LeNet network) is “leakage”. The class 1 of the discriminator is the static feature LeNet network, and the class 2 of the discriminator is the dynamic feature LeNet network.

To be specific, final fault diagnosis results of the dynamic feature and the static feature are fused through the D-S evidence theory.

Diagnosis result of dynamic-static feature LeNet networks obtained by fusing through D-S evidence theory=

$$( \begin{matrix}\frac{Category}{Normal} & \frac{Probability}{{z}_{1}} \\ Leakage & {z}_{2}\end{matrix} ) \qquad ( 10 )$$

Dynamic-static classification probabilities are fused through the D-S evidence theory, to obtain a leakage diagnosis result of the high-pressure hydrogen cylinder for a vehicle.

The present disclosure further provides a system for diagnosing a leakage in a hydrogen system for a vehicle. The system includes: an obtaining module, a transformation module, a first recognition module, a second recognition module, and a fuse module.

The obtaining module is configured to obtain data of an actual gas pressure inside a hydrogen cylinder of a fuel cell vehicle.

The transformation module is configured to separately perform Gramian angular field transformation and Markov transition field transformation on the data of the actual gas pressure, to obtain static feature information and dynamic feature information.

The first recognition module is configured to perform, by a static feature LeNet neural network, recognition based on the static feature information, to obtain a probability output of the static feature LeNet neural network.

The second recognition module is configured to perform, by a dynamic feature LeNet neural network, recognition based on the dynamic feature information, to obtain a probability output of the dynamic feature LeNet neural network.

The fuse module is configured to perform fusion through a D-S evidence theory based on the probability output of the static feature LeNet neural network and the probability output of the dynamic feature LeNet neural network, to obtain a hydrogen leakage diagnosis result.

As an optional implementation, the transformation module specifically includes: a normalization processing and polar coordinate transformation unit, a calculation unit, a static feature information determining unit, a binning operation, a Markov transition matrix determining unit, a construction unit, and a dynamic feature information determining unit.

The normalization processing and polar coordinate transformation unit is configured to perform normalization processing and polar coordinate transformation on the data of the actual gas pressure, to obtain transformed data.

The calculation unit is configured to calculate a Gramian angular summation field based on the transformed data.

The static feature information determining unit is configured to determine the static feature information based on the Gramian angular summation field.

The binning operation unit is configured to perform a binning operation on the data of the actual gas pressure, to obtain a binning probability.

The Markov transition matrix determining unit is configured to determine a Markov transition matrix based on the binning probability.

The construction unit is configured to construct a Markov transition field based on the Markov transition matrix.

The dynamic feature information determining unit is configured to determine the dynamic feature information based on the Markov transition field.

As an optional implementation, a training process of the static feature LeNet neural network includes:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, where the different operating condition includes a normal operating condition and a hydrogen leakage condition.

The present disclosure further provides an electronic device.

The electronic device includes: one or more processors, and a storage unit.

The storage unit is configured to store one or more programs.

The one or more programs, when being executed by the one or more processors, cause the one or more processors to implement the method according to any one of the foregoing items.

The present disclosure further provides a storage medium, configured to store a computer program, where the computer program, when being executed by a processor, implements the method according to any one of the foregoing items.

According to the present disclosure, raw data is converted into the Gramian angular field and the Markov transition field for representation. The Gramian angular field represents a temporal correlation at different time intervals while time dependence is stored, and represents static feature information of the data: The Markov transition field is able to represent the dynamic transition information of the acquired data by calculating the Markov probability transition matrix between binning time sequence.

According to the present disclosure, a deep learning LeNet convolutional neural network is used to train models of the Gramian angular field representing the static feature and the Markov transition field representing the dynamic feature, to output the hydrogen leakage diagnosis result. An abstract representation feature of the acquired data is automatically learned. This avoids extracting a feature based on expert experience. Therefore, robustness and fault tolerance are strong, any complex nonlinear relationship is adequately approximated, and an information synthesis capability is strong.

According to the present disclosure, the parameter of the static feature LeNet neural network that has been trained can be used to train another dynamic feature LeNet neural network through migration. Therefore, training time of the network is reduced, and accuracy is improved.

According to the present disclosure, the probability output of the static feature LeNet neural network and the probability output of the dynamic feature LeNet neural network are fused through the D-S evidence theory. Because a dynamic feature and a static feature of the acquired data are comprehensively considered, an optimal diagnosis output result is obtained. Therefore, speed of diagnosis is improved.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for diagnosing a leakage in a hydrogen system for a vehicle, comprising:
obtaining data of an actual gas pressure inside a hydrogen cylinder of a fuel cell vehicle;
separately performing Gramian angular field transformation and Markov transition field transformation on the data of the actual gas pressure, to obtain static feature information and dynamic feature information;
performing, by a static feature LeNet neural network, recognition based on the static feature information, to obtain a probability output of the static feature LeNet neural network;
performing, by a dynamic feature LeNet neural network, recognition based on the dynamic feature information, to obtain a probability output of the dynamic feature LeNet neural network; and
performing fusion through a Dempster-Shafer (D-S) evidence theory based on the probability output of the static feature LeNet neural network and the probability output of the dynamic feature LeNet neural network, to obtain a hydrogen leakage diagnosis result.

2. The method for diagnosing a leakage in a hydrogen system for a vehicle according to claim 1, wherein the separately performing Gramian angular field transformation and Markov transition field transformation on the data of the actual gas pressure, to obtain static feature information and dynamic feature information specifically comprises:
performing normalization processing and polar coordinate transformation on the data of the actual gas pressure, to obtain transformed data;
calculating a Gramian angular summation field based on the transformed data;
determining the static feature information based on the Gramian angular summation field;
performing a binning operation on the data of the actual gas pressure, to obtain a binning probability;
determining a Markov transition matrix based on the binning probability;
constructing a Markov transition field based on the Markov transition matrix; and
determining the dynamic feature information based on the Markov transition field.

3. The method for diagnosing a leakage in a hydrogen system for a vehicle according to claim 1, wherein a training process of the static feature LeNet neural network comprises:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, wherein the different operating condition comprises a normal operating condition and a hydrogen leakage condition.

4. The method for diagnosing a leakage in a hydrogen system for a vehicle according to claim 3, wherein a training process of the dynamic feature LeNet neural network comprises:
migrating, based on a migration learning algorithm, a network parameter of the static feature LeNet neural network to a second LeNet neural network, taking actual dynamic feature data under the different operating conditions as an input of the second LeNet neural network, taking a probability output of the LeNet neural network with dynamic feature input extracted under actual conditions as an output of the second LeNet neural network, and optimizing a network parameter of the second LeNet neural network, to obtain the dynamic feature LeNet neural network.

5. The method for diagnosing a leakage in a hydrogen system for a vehicle according to claim 1, wherein the performing fusion through a Dempster-Shafer (D-S) evidence theory based on the probability output of the static feature LeNet neural network and the probability output of the dynamic feature LeNet neural network, to obtain a hydrogen leakage diagnosis result specifically comprises:
determining a normalization constant based on the probability output of the static feature LeNet neural network and the probability output of the dynamic feature LeNet neural network;
determining, through a Dempster evidence synthesis rule, a combined basic probability assignment based on the probability output of the static feature LeNet neural network, the probability output of the dynamic feature LeNet neural network, and the normalization constant; and
determining the hydrogen leakage diagnosis result based on the combined basic probability assignment.

6. A system for diagnosing a leakage in a hydrogen system for a vehicle, comprising:
an obtaining module configured to obtain data of an actual gas pressure inside a hydrogen cylinder of a fuel cell vehicle;
a transformation module configured to separately perform Gramian angular field transformation and Markov transition field transformation on the data of the actual gas pressure, to obtain static feature information and dynamic feature information;
a first recognition module configured to perform, by a static feature LeNet neural network, recognition based on the static feature information, to obtain a probability output of the static feature LeNet neural network;
a second recognition module configured to perform, by a dynamic feature LeNet neural network, recognition based on the dynamic feature information, to obtain a probability output of the dynamic feature LeNet neural network; and
a fuse module configured to perform fusion through a D-S evidence theory based on the probability output of the static feature LeNet neural network and the probability output of the dynamic feature LeNet neural network, to obtain a hydrogen leakage diagnosis result.

7. The system for diagnosing a leakage in a hydrogen system for a vehicle according to claim 6, wherein the transformation module specifically comprises:
a normalization processing and polar coordinate transformation unit configured to perform normalization processing and polar coordinate transformation on the data of the actual gas pressure, to obtain transformed data;
a calculation unit configured to calculate a Gramian angular summation field based on the transformed data;
a static feature information determining unit configured to determine the static feature information based on the Gramian angular summation field;
a binning operation unit configured to perform a binning operation on the data of the actual gas pressure, to obtain a binning probability;
a Markov transition matrix determining unit configured to determine a Markov transition matrix based on the binning probability;
a construction unit configured to construct a Markov transition field based on the Markov transition matrix; and
a dynamic feature information determining unit configured to determine the dynamic feature information based on the Markov transition field.

8. The system for diagnosing a leakage in a hydrogen system for a vehicle according to claim 6, wherein a training process of the static feature LeNet neural network comprises:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, wherein the different operating condition comprises a normal operating condition and a hydrogen leakage condition.

9. An electronic device, comprising:
one or more processors; and
a storage unit, configured to store one or more programs, wherein
the one or more programs, when being executed by the one or more processors, cause the one or more processors to implement the method according to claim 1.

10. The electronic device according to claim 9, comprising:
wherein the separately performing Gramian angular field transformation and Markov transition field transformation on the data of the actual gas pressure, to obtain static feature information and dynamic feature information specifically comprises:
performing normalization processing and polar coordinate transformation on the data of the actual gas pressure, to obtain transformed data;
calculating a Gramian angular summation field based on the transformed data;
determining the static feature information based on the Gramian angular summation field;
performing a binning operation on the data of the actual gas pressure, to obtain a binning probability;
determining a Markov transition matrix based on the binning probability;
constructing a Markov transition field based on the Markov transition matrix; and
determining the dynamic feature information based on the Markov transition field.

11. The electronic device according to claim 9, wherein a training process of the static feature LeNet neural network comprises:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, wherein the different operating condition comprises a normal operating condition and a hydrogen leakage condition.

12. The electronic device according to claim 11, wherein a training process of the dynamic feature LeNet neural network comprises:
migrating, based on a migration learning algorithm, a network parameter of the static feature LeNet neural network to a second LeNet neural network, taking actual dynamic feature data under the different operating conditions as an input of the second LeNet neural network, taking a probability output of the LeNet neural network with dynamic feature input extracted under actual conditions as an output of the second LeNet neural network, and optimizing a network parameter of the second LeNet neural network, to obtain the dynamic feature LeNet neural network.

13. The electronic device according to claim 9, wherein the performing fusion through a Dempster-Shafer (D-S) evidence theory based on the probability output of the static feature LeNet neural network and the probability output of the dynamic feature LeNet neural network, to obtain a hydrogen leakage diagnosis result specifically comprises:
determining a normalization constant based on the probability output of the static feature LeNet neural network and the probability output of the dynamic feature LeNet neural network;
determining, through a Dempster evidence synthesis rule, a combined basic probability assignment based on the probability output of the static feature LeNet neural network, the probability output of the dynamic feature LeNet neural network, and the normalization constant; and
determining the hydrogen leakage diagnosis result based on the combined basic probability assignment.

14. A storage medium, configured to store a computer program, wherein the computer program, when being executed by a processor, implements the method according to claim 1.

15. The storage medium according to claim 14, wherein the separately performing Gramian angular field transformation and Markov transition field transformation on the data of the actual gas pressure, to obtain static feature information and dynamic feature information specifically comprises:
performing normalization processing and polar coordinate transformation on the data of the actual gas pressure, to obtain transformed data;
calculating a Gramian angular summation field based on the transformed data;
determining the static feature information based on the Gramian angular summation field;
performing a binning operation on the data of the actual gas pressure, to obtain a binning probability;
determining a Markov transition matrix based on the binning probability;
constructing a Markov transition field based on the Markov transition matrix; and
determining the dynamic feature information based on the Markov transition field.

16. The storage medium according to claim 14, wherein a training process of the static feature LeNet neural network comprises:
taking actual static feature data under different operating conditions as an input of a first LeNet neural network, taking a probability output of a LeNet neural network with static feature input extracted under actual conditions as an output of the first LeNet neural network, and optimizing a network parameter of the first LeNet neural network, to obtain the static feature LeNet neural network, wherein the different operating condition comprises a normal operating condition and a hydrogen leakage condition.

17. The storage medium according to claim 16, wherein a training process of the dynamic feature LeNet neural network comprises:
migrating, based on a migration learning algorithm, a network parameter of the static feature LeNet neural network to a second LeNet neural network, taking actual dynamic feature data under the different operating conditions as an input of the second LeNet neural network, taking a probability output of the LeNet neural network with dynamic feature input extracted under actual conditions as an output of the second LeNet neural network, and optimizing a network parameter of the second LeNet neural network, to obtain the dynamic feature LeNet neural network.

18. The storage medium according to claim 14, wherein the performing fusion through a Dempster-Shafer (D-S) evidence theory based on the probability output of the static feature LeNet neural network and the probability output of the dynamic feature LeNet neural network, to obtain a hydrogen leakage diagnosis result specifically comprises:
determining a normalization constant based on the probability output of the static feature LeNet neural network and the probability output of the dynamic feature LeNet neural network;
determining, through a Dempster evidence synthesis rule, a combined basic probability assignment based on the probability output of the static feature LeNet neural network, the probability output of the dynamic feature LeNet neural network, and the normalization constant; and
determining the hydrogen leakage diagnosis result based on the combined basic probability assignment.
